(19) United States
(12) Patent Application Publication
(10) Pub. No.: US 2022/0298829 A1
(43) Pub. Date: Sep. 22, 2022

(54) LOCK

(71) Applicant: TriTeq Lock and Security, LLC, Elk Grove Village, IL (US)

(72) Inventors: Calin Roatis, Long Grove, IL (US); Gabriel Ribu, Niles, IL (US); William D. Denison, North Barrington, IL (US)

(21) Appl. No.: 17/713,131

(22) Filed: Apr. 4, 2022

Related U.S. Application Data
(63) Continuation of application No. PCT/US2020/054118, filed on Oct. 2, 2020.
(60) Provisional application No. 62/910,987, filed on Oct. 4, 2019.

(51) Int. Cl. E05B 47/06; E05B 57/00; E05B 63/18

(52) U.S. Cl. CPC E05B 47/0607; E05B 57/00; E05B 63/18; E05B 2047/0025

(57) ABSTRACT

A lock includes a housing assembly, an actuatable lock assembly and a latching assembly. The actuatable lock assembly is positionable in a closed orientation and an open orientation. The latching assembly includes a latch, a cam and a motor. The latch, having a cam profile, is movable between a locked and an unlocked position. The cam is rotatably mounted and has a first follower configured to intermittently coact with the cam profile of the latch, to, in turn, move the latch between the locked position and the unlocked position. The motor is coupled to the cam. Actuation of the motor causes rotation of the cam, resulting in movement of the latch between the locked and unlocked positions. The actuatable lock assembly includes a catch member that is configured to pivot about a pivot axle, wherein the latch controls the pivoting of the catch member, selectively precluding and allowing the same.

### CROSS-REFERENCE TO RELATED APPLICATION

The present application is a continuation of PCT Patent Application No. PCT/US2020/054118 filed Oct. 2, 2020, entitled “LOCK”, the entire specification of which is hereby incorporated by reference in its entirety, which claims priority to U.S. Provisional Patent Application Ser. No. 62/910,987, filed Oct. 4, 2019, entitled “LOCK”, the entire specification of which is hereby incorporated by reference, and related to (without claiming priority from) PCT Patent Application No. PCT/US2014/038016 filed May 14, 2014, entitled “Lock” the entire specification of which is hereby incorporated by reference, which application claims priority from U.S. Provisional Patent Application Ser. No. 61/823,685, filed May 15, 2013, entitled “Hybrid-Electronic Core Lock”, the entire specification of which is hereby incorporated by reference.

### BACKGROUND OF THE DISCLOSURE

### 1. Field of the Disclosure

The disclosure relates in general to locks, and more particularly, to a core lock that is configured to provide electronic locking and unlocking of a lock. While not limited thereto, such a lock is well suited for use in association with furniture and cabinets, including as a retrofit to existing furniture and cabinets. Of course, the lock is not limited to such use or to such a field of use, and the foregoing is solely for purposes of example.

### 2. Background Art

Many cabinets, desks, and other storage applications utilize locks that include a shell mounted on the door or cabinet, and an insertable and removable lock core that plugs into the shell. The shell not only houses the core, but also attaches to a driver for accomplishing the locking and unlocking function when rotated. The lock core acts to lock the driver in place when there is no key inserted in the lock core due to lock core tumblers that protrude into the shell to restrict the lock core and driver from rotation.

When the correct key is inserted in the lock core, the protruding tumblers move with respect to the cuts in the key blade and no longer protrude into the shell and no longer restrict rotation of the lock core. As the lock core is turned by the user rotating the key, drive serves to drive a cam or locking bar to the unlocked position.

Such systems are ubiquitous, however, there are nevertheless drawbacks. For example, such systems typically have a vast number of different tumbler configurations, and corresponding keys associated with each such different tumbler configuration. As a result, a supplier must include a relatively large supply of spare locks, tumblers and keys to match those that are out in the field. Additionally, the removal and replacement of such locks (necessitated by the changing of the duty of a piece of furniture, dismissal of an employee, loss of a set of keys, etcetera) is very time consuming and labor intensive.

### SUMMARY OF THE DISCLOSURE

The disclosure is directed to a lock comprising a housing, an actuatable lock assembly, and a latching assembly. The housing assembly has an actuatable lock cavity and a transverse catch slot providing ingress thereinto. The actuatable lock assembly is positioned within the actuatable lock cavity, and includes a catch member rotatably coupled to the housing. The catch member has a jamb slot that slidably accessible through the transverse catch slot when in an open orientation and slidably inaccessible when in a closed orientation. The latching assembly further includes a latch, a blocker, a cam and a motor. The latch slidably extends at least partially into the actuatable lock cavity and is interfaceable with the catch member wherein the latch assembly can block rotation of the catch member from the closed orientation to the open orientation. The blocker is positioned within the housing assembly and movable between a locked position and an unlocked position. In the locked position, the blocker precludes movement the latch sufficient to block rotation of the catch member from the closed orientation to the open orientation. The blocker also has a cam profile. The cam is rotatably mounted within the housing assembly. The cam has a first follower configured to intermittently coact with the cam profile of the blocker, to, in turn, move the blocker between the locked position and the unlocked position. The motor is coupled to the cam so as to have the same axis of rotation. Actuation of the motor causes rotation of the cam, and, in turn, movement of the blocker between the locked and unlocked position.

In some configurations, the cam profile further comprises an uneven contact profile surface having a concave portion on an outer surface of the uneven contact profile surface.

In some configurations, the uneven contact profile surface comprises a combination of at least one of a slot and a ridge. In some such configurations, the uneven contact profile surface further comprises a combination of at least one of a peak and a ramp.

In some configurations, the first follower is configured to continue rotating after the blocker reaches the locked position, independent of movement of the cam profile. Also, the follower is configured to continue rotating after the blocker reaches the unlocked position, independent of movement of the cam profile.

In some configurations, the motor includes an axle extending therefrom and directly rotatably coupled to the cam so as to have the same axis of rotation.

In some configurations, the latch has a proximal end and a distal end, with the proximal end interfaceable with the blocker. Also, the catch member further includes a latch interface surface that is interfaceable with the distal end of the latch, the latch interface surface having a locked portion, an unlocked portion and a radial portion. When the catch member is in the closed configuration, and the blocker is in the locked position, the distal end of the latch cooperates with the radial portion to preclude further rotation of the catch member.

In some configurations, the catch member further includes a guide slot with a guide pin slidably positionable within the guide slot while being fixed relative to the housing, wherein the guide slot defines the range of rotation of the catch member relative to the housing assembly.

In some configurations, the lock further has a return spring having a first end coupled to the housing and a second end coupled to the catch member. The return spring directs the catch member so that a first end of the guide slot interfaces with the guide pin when in an open configuration and also directs the catch member so that a second end of the guide slot interfaces with the guide pin when in a closed configuration.

In some configurations, the lock includes a spring biasing the distal end of the latch toward the latch interface.

In some configurations, the lock has a second member having a striker hoop, wherein the striker hoop is insertable into the transverse catch slot and into the guide slot when in the open configuration. Further insertion into the transverse catch slot rotates the catch member toward the closed configuration.

In some configurations, the striker hoop is capturable by the transverse catch member and the guide slot when the catch member is in the closed configuration.

In some configurations, the blocker is slidably movable along a blocker channel of the housing assembly. Additionally, the latch is slidably movable along a latch channel of the housing assembly. In some such configurations, the blocker channel and the latch channel are substantially perpendicular to each other. In some other such configurations, the blocker channel is substantially perpendicular to an axis of rotation of the cam.

In some configurations, the latch channel includes a latch opening providing ingress into the actuatable lock cavity.

In some configurations, upon actuation of the motor, from either the locked or unlocked position, the cam rotates through an initial arcuate distance prior to imparting a force upon the blocker to slidably move the same into the other of the locked or unlocked position. In some configurations, the initial arcuate distance comprises approximately half of a revolution.

In some configurations, the blocker further includes a second cam profile disposed thereon. The first and second cam profiles are substantially parallel to each other defining a longitudinal channel therebetween. The cam further includes a body and a second follower. The first follower extends from a first side of the body and the second follower extending from a second side of the body. The first cam follower interfaces with the cam profile and the second cam follower interfaces with the second cam profile, with the body of the cam positioned at least partially within the longitudinal channel.

In some configurations, the cam profile includes a first slot, a second slot and a third slot, with a first ridge defined between the first slot and the second slot, and a second ridge defined between the second slot and the third slot. The width of the second slot is at least as wide as the follower, such that when the follower engages the second slot, further rotation slidably moves the blocker.

In another aspect of the disclosure, the disclosure is directed to a lock for securing a volume to be protected having a closure member, with the closure structure providing ingress into the volume to be protected comprising a first member a first member coupled to one of the volume to be protected and the closure member and a second member coupled to the other thereof. The first member comprises a housing, an actuatable lock assembly, and a latching assembly. The housing assembly has an actuatable lock cavity and a transverse catch slot providing ingress thereinto. The actuatable lock assembly is positioned within the actuatable lock cavity, and includes a catch member rotatably coupled to the housing. The catch member has a jamb slot that slidably accessible through the transverse catch slot when in an open orientation and slidably inaccessible when in a closed orientation. The latching assembly further includes a latch, a blocker, a cam and a motor. The latch slidably extends at least partially into the actuatable lock cavity and is interfaceable with the catch member wherein the latch assembly can block rotation of the catch member from the closed orientation to the open orientation. The blocker is positioned within the housing assembly and movable between a locked position and an unlocked position. In the locked position, the blocker precludes movement the latch sufficient to block rotation of the catch member from the closed orientation to the open orientation. The blocker also has a cam profile. The cam is rotatably mounted within the housing assembly. The cam has a first follower configured to intermittently coact with the cam profile of the blocker, to, in turn, move the blocker between the locked position and the unlocked position. The motor is coupled to the cam so as to have the same axis of rotation. Actuation of the motor causes rotation of the cam, and, in turn, movement of the blocker between the locked and unlocked position. The second member comprises a striker hoop. The striker hoop is insertable into the transverse catch slot and into the guide slot when in the open configuration, and wherein further insertion into the transverse catch slot rotates the catch member toward the closed configuration. This then corresponds to a closed configuration of the closure member relative to the volume to be protected.

In some configurations, the second member further includes a base plate, with the striker hoop extending from the base plate and with the base plate being attached to the one of the volume to be protected and the closure member.

In some configurations, the volume to be protected comprises one of a doors, drawers, cabinets, pantries, lockers, desks, credenzas, and wardrobes.

In some configurations, the closure member comprises a door or a drawer.

In some configurations, the housing assembly further comprises a bottom, a first side, a second side, a first end and a second end. The bottom is attached to the one of the volume to be protected and the closure member. A cover that is releasably attachable to the at least one of the base, the first side, the second side, the first end or the second end.

In some configurations, the motor is controlled by an electronic control system a portion of which is positioned within the housing assembly.

In some configurations, the electronic control assembly includes an input device, which comprises at least one of a key, a keypad having a plurality of keys, a receiver structurally configured for receipt of wireless signals from key cards, mobile phones, or other devices.

### BRIEF DESCRIPTION OF THE DRAWINGS

The disclosure will now be described with reference to the drawings wherein:

FIG. 1 of the drawings is a side elevational view of the lock of the present disclosure, showing, in particular, the body 19 of the housing assembly (essentially comprising a first member) coupled to one structure 200, and the second member 80 coupled to another structure 202, with the structures being movable relative to each other so as to bring the body 19 and the second member 80 into engagement;

FIG. 2 of the drawings is a perspective view of the lock of the present disclosure, showing, in particular, a locked configuration;

FIG. 3 of the drawings is a perspective view of the lock of the present disclosure, showing, in particular, the locked configuration with the cover removed;

FIG. 4 of the drawings is a top plan view of the body of the housing assembly;

FIG. 5 of the drawings is a perspective view of the latching assembly in a locked configuration, wherein the blocker is positioned to block movement of the latch;

FIG. 6 of the drawings is a perspective view of the electronic control assembly (or, at least a portion thereof);

FIG. 7 of the drawings is a top plan view of the body of the housing assembly with the actuatable lock assembly positioned in an operable configuration, and in the locked configuration;

FIG. 8 of the drawings is a perspective view of the actuatable lock assembly in the locked configuration;

FIG. 9 of the drawings is a top plan view of the actuatable lock assembly in the locked configuration;

FIG. 10 of the drawings is a perspective view of the lock of the present disclosure, showing, in particular, the unlocked configuration with the cover removed;

FIG. 11 of the drawings is a perspective view of the latching assembly in the unlocked configuration, wherein the blocker is positioned so that movement of the latch is not precluded by the blocker;

FIG. 12 of the drawings is a perspective view of the blocker of the present disclosure;

FIG. 13 of the drawings is a perspective view of the blocker of the present disclosure;

FIG. 14 of the drawings is a perspective view of the cam of the present disclosure;

FIG. 15 of the drawings is a perspective view of the cam of the present disclosure;

FIG. 16 of the drawings is a perspective view of the latch of the present disclosure;

FIG. 17 of the drawings is a perspective view of the second member of the lock of the present disclosure; and

FIG. 18 of the drawings is a top plan view of the actuatable lock assembly in the locked configuration, with the catch member reaching the end of travel in the clockwise direction.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

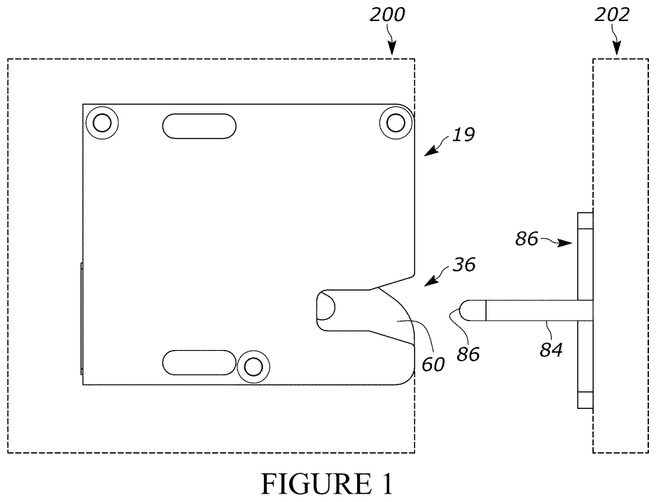

Referring now to the drawings and, in particular, to FIGS. 1 through 3, the lock of the present invention is shown generally at 10. The lock 10 may be utilized in a number of different environments and in association with a number of different installations, including but not limited to, doors, drawers, cabinets, pantries, lockers, desks, etc. One particular use of the lock is in the office furniture application (i.e., desks, credenzas, cabinets, wardrobes, etc.). Of course, the disclosure is not limited to use in association with such applications. One of the components can be coupled to a first structure 200 (which may comprise a volume to be protected) with the other being coupled to the second structure 202 (which may comprise a door, drawer, or other closure member), or vice versa, wherein the first structure may comprise a door, drawer or other closure member, and the second structure may comprise a volume to be protected. The closure member providing access to the volume to be protected.

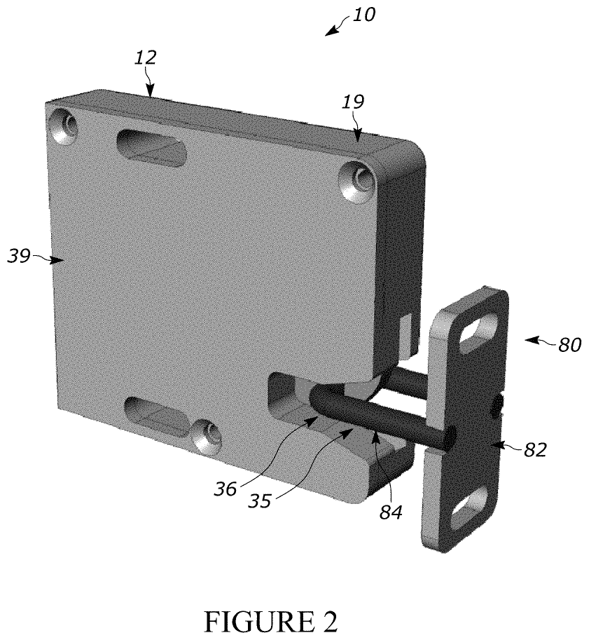

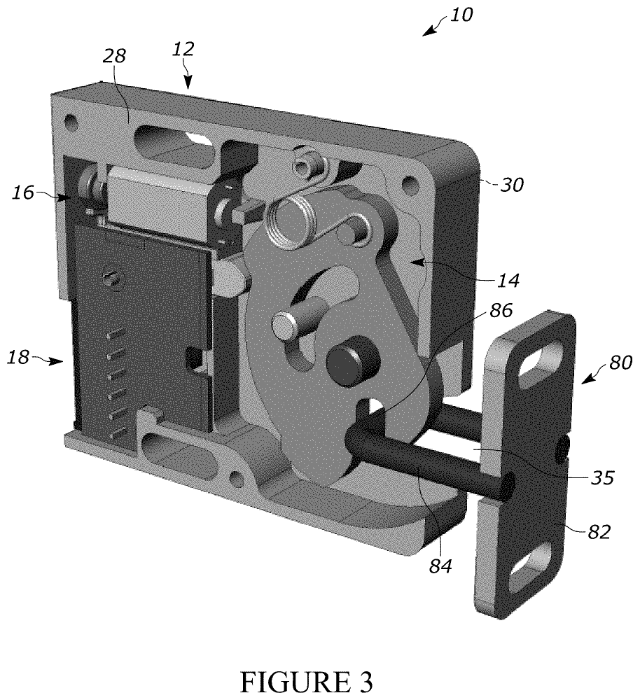

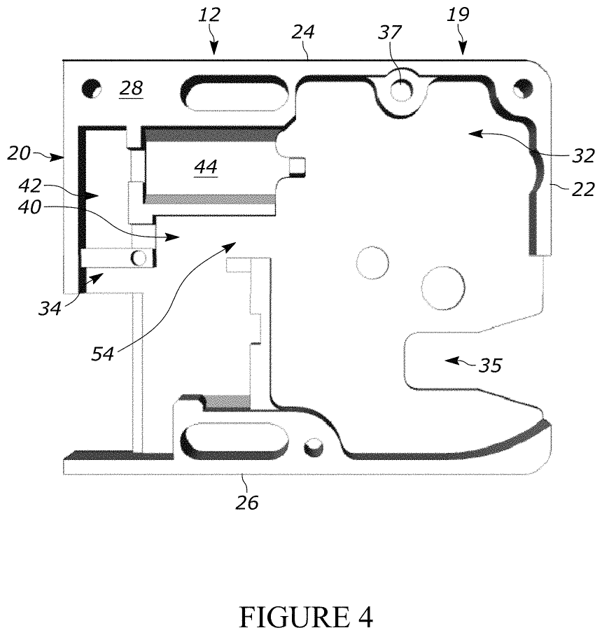

Referring again to FIGS. 2 and 3, the lock 10 is shown as including housing assembly 12, actuatable lock assembly 14, latching assembly 16 and electronic control assembly 18. With reference to FIGS. 2, 3 and 4, the housing assembly 12 comprises a body 19 with first end 20, second end 22, first side 24 and second side 26, top 28 and bottom 30 and a cover 39 which can be fastened to the body 19 through, for example, fasteners that extend through openings in the cover and into the body. The body assembly is shown as comprising a single cast member, although other configurations are contemplated. The single cast member may comprise a metal or alloy thereof, or may comprise a composite or polymer material.

The body 19 of the housing assembly includes a plurality of walls that define a plurality of cavities, including the latch assembly cavity 34 and the actuatable lock cavity 32. The latch assembly cavity 34 includes latch channel 40, blocker channel 42, motor retaining region 44, electronics region 46 and the latch opening 54 which provides communication to the actuatable lock cavity from the latch assembly cavity. The latch channel and the motor retaining region are generally parallel to each other in the configuration shown so that the latch and the axle of the motor are generally in a parallel disposition (while other configurations are contemplated). The blocker channel is positioned at an end of the motor retaining region and the latch channel (opposite the latch opening) and generally perpendicular to each of the latch channel and the motor retaining region.

Both the body 19 and the cover 39 include a transverse latch slot 35 that extends from the second end toward the first end, which catch slot is configured to receive a striker hoop 84 of the second member 80 (as will be explained below). The transverse latch slot has a narrowing configuration so that the slot is generally widest proximate the second end and narrows away from the second end. In the configuration shown, the slot is substantially identical on the body and the cover. Of course, in other configurations, the transverse slot may be different in each of the body and the cover, and, in turn, the slot may be eliminated from the cover.

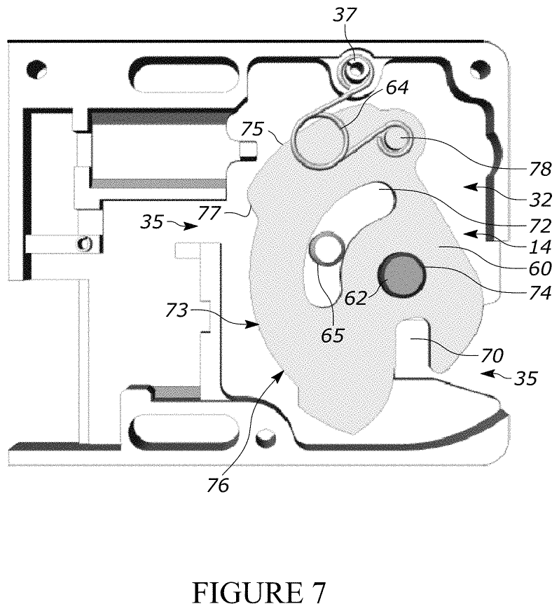

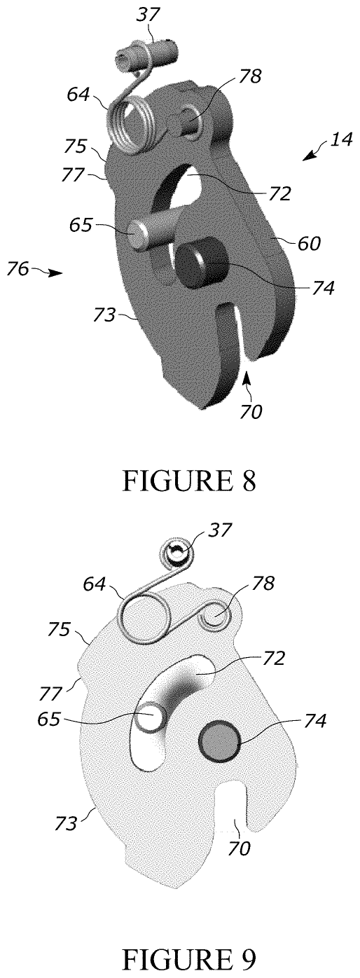

Referring now to FIGS. 7 through 10 the actuatable lock assembly includes catch member 60, pivot axle 62, return spring 64 and guide pin 65. The catch member comprises a generally planar member that is positioned with (and pivotable within) the actuatable lock cavity of the housing assembly. The catch member has an axle opening 74 through which the pivot axle 62 is directed so that when the pivot axle is fixed to the body 19 of the housing assembly, the catch member pivots about the pivot axle.

The catch member further includes jamb slot 70, guide slot 72, latch interface surface 76 and spring coupling 78. In the configuration shown, the catch member comprises a substantially uniformly thick member. It will be understood that the jamb slot 70 interfaces with the transverse catch slot 35. As will be explained below, the latch interface surface 76, when pivoted, moves across the latch opening 54 and is engageable with the distal end 112 of the latch 102.

In particular, the latch interface surface 76 includes locked portion 73, unlocked portion 75 and radially extending connection portion 77. The locked portion and the unlocked portion comprise arcuate configurations whose radius of curvature is centered proximate or at the pivot axle 62. The radius of the locked portion is smaller than that of the unlocked portion, such that the radially extending connection portion spans between the two portions. As will be explained, when the distal end 112 engages the locked portion 73, the latch extends further through the latch opening 54 of the body 19 of the housing into the actuatable lock cavity than when the distal end engages the unlocked portion 75. Thus, and as will be explained below, when the latch engages with the locked portion 73 and is precluded from inward movement out of the actuatable lock cavity 32, the latch precludes pivoting of the catch member once the latch reaches the radial connection portion 77.

The guide pin 65 is coupled to the body of the housing assembly in such a configuration that the guide pin 65 extends through the guide slot 72 to further facilitate the pivoting motion, and, also to preclude inadvertent undesirable movement of the catch member, and to facilitate the proper pivoting of the catch member about the pivot axle 62.

The return spring 64 is coupled at the one end to the spring coupling 78 on the catch member 60 and at the second end to the spring coupling 37 of the body 19 of the housing assembly 12. The spring biases outwardly when the lock is in the unlocked configuration to help release the components from engagement. Further spring also biases the inwardly when the striker hoop is inserted to assist in the engagement of the striker hoop with the catch member. That is, the in the unlocked configuration, the spring biases the catch member to rotate in a first direction (in the Figures shown, a counterclockwise direction, toward the unlocking and release of the striker hoop). On the other hand, when in the locked configuration, the spring biases the catch member to rotate in a second direction (in the Figures shown, a clockwise direction, toward the locking and retention of the striker hoop), thereby pulling the striker hoop inwardly or biasing against outward movement.

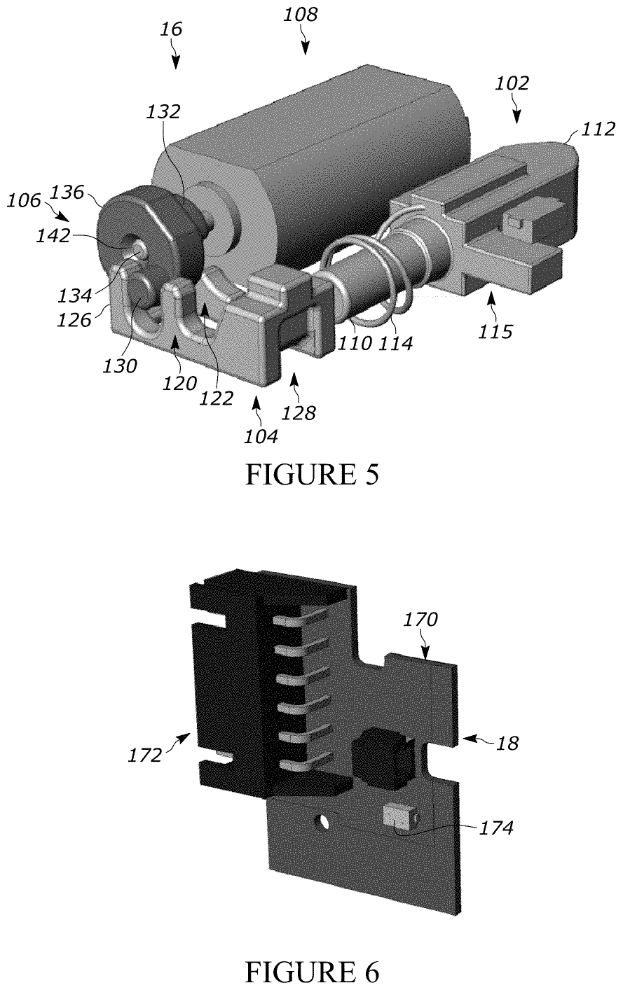

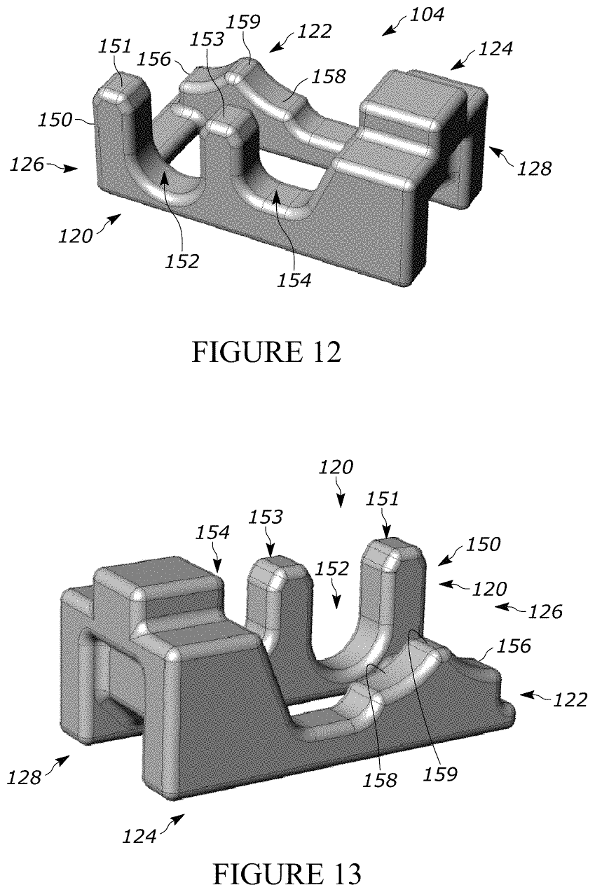

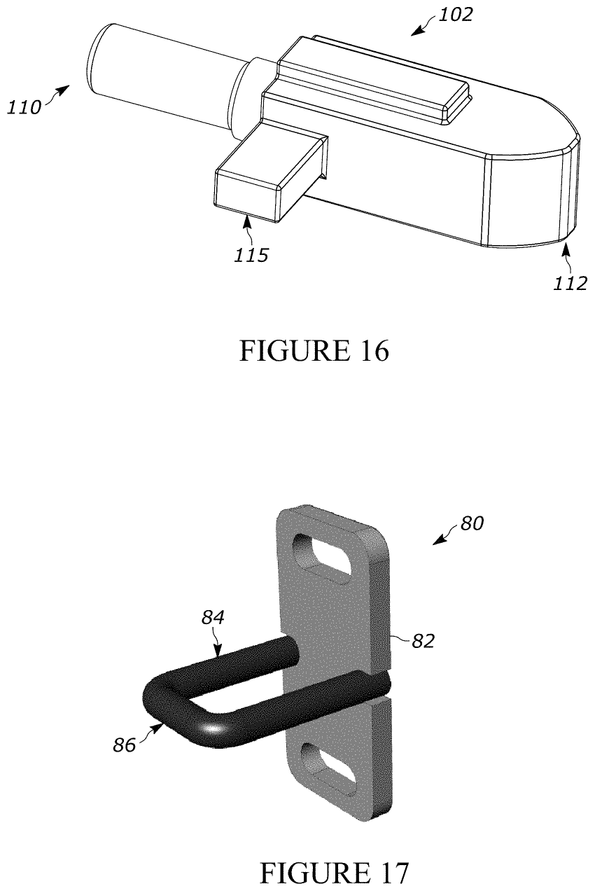

Referring now to FIGS. 5 and 11 through 16 the latching assembly 16 is shown as comprising latch 102, blocker 104, cam 106 and motor 108 (with axle 142). It will be understood that FIGS. 12A and 12B show the blocker in the locked position, and, the FIGS. 13A and 13B show the blocker in the unlocked position. The latch 102 includes proximal end 110 and distal end 112. The latch 102 is positioned within the latch channel 40 and is slidably movable therewithin. In the locked position, which is shown in FIGS. 12A and 12B, and as will be explained, the distal end 112 of the latch 102 extends into contact with the latch interface surface 76 of the catch member 60.

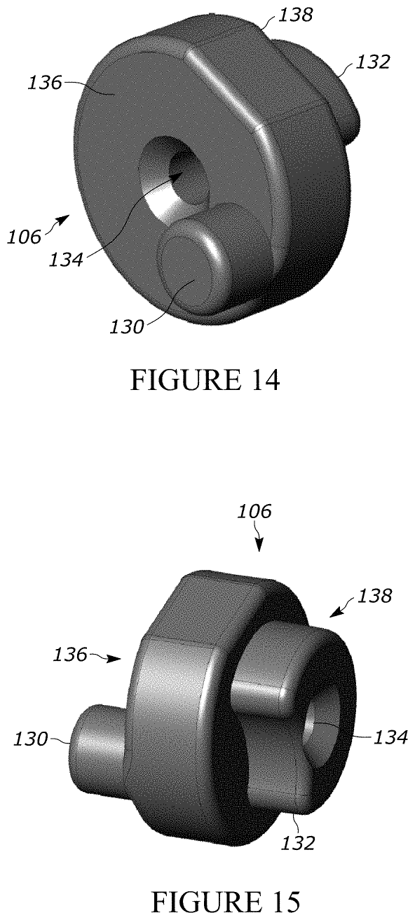

The proximal end 110 is configured to interface with the blocker 104. With further reference to FIG. 14 a biasing member, in the form of a compression spring 114 extends between the latch and the housing assembly so as to bias the distal end of the latch toward the latch interface surface 76 of the catch member 60. Additionally, a flag or flange 115 extends transversely from the latch. As will be explained, the flag 115 interfaces with a position sensor and provides to the position sensor the orientation and position of the latch. In other embodiments, other mechanism may be utilized for monitoring the position of the latch.

With reference to FIGS. 12 and 13, the blocker 104 is shown as comprising first cam profile 120, second cam profile 122, latch engagement body 124. The latch engagement body 124 is positioned at a second end 128 of the blocker 104. The first cam profile 120 extends between the first end 126 and the latch engagement body 124. Similarly, the second cam profile 122 extends between the first end 126 and the latch engagement body 124 in a generally parallel and spaced apart orientation from the first cam profile. The spaced apart orientation of the two cam profiles defines a longitudinal channel therebetween. It will be understood that the cam body rotatably extends through the longitudinal channel as the followers thereof interact with the first and second cam profiles.

The first cam profile 120 includes first slot 150, second slot 152, and third slot 154. A first ridge 151 is defined between the first slot 150 and the second slot 152. A second ridge 153 is defined between the second slot 152 and the third slot 154. In the embodiment shown, the first slot 150 is formed on the outside of the first ridge 151, however, provides a single sided slot function. The second cam profile 122 includes first ramp 156, second ramp 158 and peak 159 positioned therebetween.

In the embodiment shown, the blocker comprises a metal member, such as zinc or the like. Of course, other materials are contemplated. It will be understood that the blocker is the component that precludes latch movement in the event that that one tries to defeat the lock. As such, the latch engagement body 124 may comprise a solid member that provides the necessary strength to overcome the forces that may be exerted against the latch.

With reference to FIGS. 14 and 15, the cam 106 includes a body having a first side 136 and a second side 138, and, an axis of rotation 134. The first side includes first follower 130 and the second side includes second follower 132. The cam is rotatably coupled to the motor 108 about axle 142. It will be understood that the motor is positioned within the motor retaining region with the axle extending into the blocker channel. The cam 106 can also be positioned so that the body is within the longitudinal channel between the first and second cam profiles, the first follower 130 is configured to interface with the first cam profile 120 and the second follower 132 is configured to interface with the second cam profile 122.

It is contemplated that other cam profiles and other cam follower configurations may be utilized to achieve the intermittent interaction therebetween, to, translate the blocker along the blocker channel between a blocking position and a released position. It is further contemplated that the position of the two cam profiles can be swapped. Additionally, the blocker may have alternate configurations for the first cam profile or the second cam profile. For example, additional slots may be presented, and corresponding ridges to increase the stroke of the blocker movement through additional rotation and interaction with the cam, if necessary.

Referring now to FIGS. 2 and 6, the electronic control assembly 18 includes electronic PC board 170, input device 172, and latch position sensor 174. The PC board 170 (along with additional boards that may be plugged into PC board 170 in some configurations through the connector shown) includes the logic necessary to understand and process the signals coming from the input device 172 and the latch position sensor 174, so as to appropriately direct the actuation and direction of the motor 108. The configuration and design of such PC boards to achieve the desired functions set forth below are known to those of skill in the art. The input device 172 may comprise a keypad having a plurality of keys, or, a receiver for receipt of wireless signals (i.e., IR, RF, Bluetooth, zigbee, wife among others) from key cards, mobile phones, or other devices.

The latch position sensor 174 is positioned in an orientation that is in a close relationship with position flange 115 such that the sensor can determine the orientation and position of the latch relative to the housing assembly. It is contemplated that the sensor is positioned on the PC board. The PC board is configured to reside within the main body cavity of the housing assembly.

It will further be understood that a position sensor can be configured to sense the position of the latch. Alternatively, a different type of sensor can be utilized to determine the position of the latch 102. The position sensor, it is contemplated may be of the optical type. To prolong the life of the battery, it is contemplated that the sensor intermittently detects the position and a change in position (i.e., a few milli-seconds every 1-2 second period). Of course, the sensor can be configured for a different intermittent interval, or, may be configured for a continuous or generally continuous sensing.

With reference to FIG. 17, the second member 80 which cooperates in the remainder of the lock includes base plate 82 and striker hoop 84. The striker hoop 84 is attached to the base plate 82 and includes contact portion 86. The contact portion, as will be explained below, is configured and shaped to be inserted through the transverse catch slot 35 so as to engage the jamb slot 70. In the configuration shown, the striker hoop 84 comprises a u-shaped configuration wherein the ends of the u-shaped configuration extend from the base plate 82. It will be understood that it is contemplated that the second member 80 may be attached to a movable portion (such as a door 202) with the first portion of the lock 10 being attached to the fixed portion (the frame of the door, cabinet, credenza, locker, among others 200). In other configurations, this may be reversed such that the second portion is attached to the fixed portion. In some configurations, both of the structures may be mounted to movable components, such as a pair of sliding doors or the like. It will be understood that depending on the configuration either component may be utilized in any one of a number of configurations.

In operation of the preferred embodiment, the lock is disposed in an operational environment which may be to secure a volume to be protected, such as a cabinet, credenza, locker, or other structure which may be fixed or mobile, for example. The housing assembly may be coupled to the underlying structure through any number of different structures, including brackets, fasteners, adhesives, and the like. Similarly, the second member 80 may be coupled to the underlying structure through any number of different structures.

Initially, with reference to FIGS. 3 and 5, portions of the lock are shown in the locked configuration. In such a configuration, the blocker is in the blocking position, at the locked end of the blocker channel. The latch 102 is positioned within the latch channel with the distal end 112 of the latch 102 biased by the biasing member 114 through the latch opening 54 and into contact with the locked portion 73 of the latch interface surface 76. The latch is precluded from slidable movement within the latch channel 40, by the position of the blocker. In some embodiments, the proximal end 110 of the latch 102 abuts the latch engagement body 124. In other embodiments, the biasing member 114 maintains a small separation between the latch and the blocker, for example, due to the biasing member. Regardless of the interface, the blocker precludes the movement of the latch so that the distal end of the latch remains extended into the actuatable lock cavity and in engagement with the locked portion 73.

In such a configuration, the striker hoop 84 is maintained within the jamb slot 70 and the jamb slot is substantially vertical, extending through at least a portion of the transverse catch slot. In such a configuration, the catch member is precluded from rotation sufficient to enable the striker hoop 84 to be removed from within the jamb slot and then out from the transverse catch slot. That is, the latch cannot be forced sufficiently away from the catch member to allow for the passage of the radial connection portion of the catch member to pass beyond the latch.

Additionally, in the locked configuration, the cam 106 is rotated such that the first follower 130 engages the first cam profile at the first slot 150. At the same time, the second follower engages the first ramp 156. Such a configuration is also shown at FIG. 19A with respect to the motor, cam and blocker. As will be explained below, the sequence of moving the blocker from a locked position to an unlocked position is achieved through rotation of the cam through approximately one and one half revolutions (although variations are contemplated which require lesser or greater revolutions of the cam and the motor.

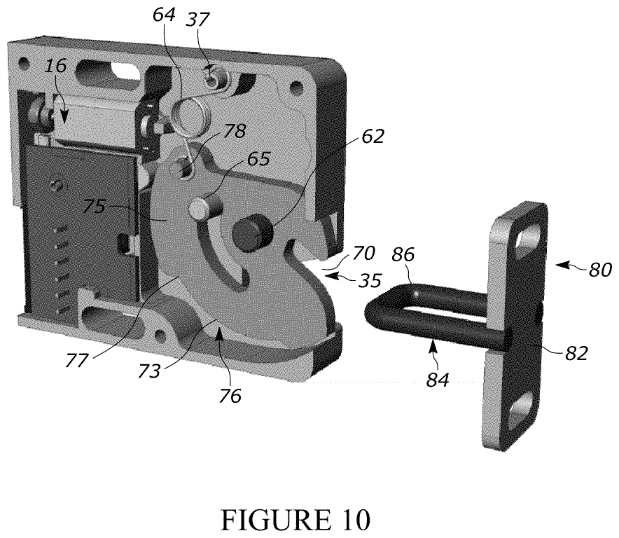

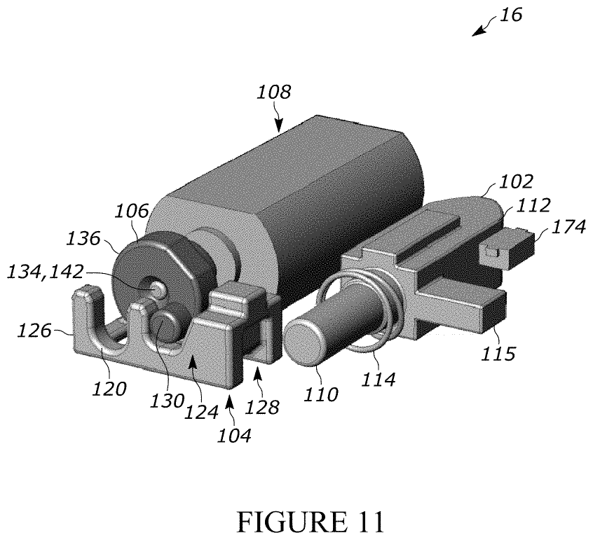

To unlock the lock so that the catch member 60 can rotate, and with reference to FIGS. 10 and 11, the user must direct the PC board to initiate an unlocking procedure. In one embodiment, some type of authorization (depending on the manner that the user interacts with the lock) is provided to the electronic control assembly. Regardless of the method of communicating the proper combination or code for initiating the unlocking procedure, once the procedure is initiated, the position of the latch is determined through sensor 174, and the motor is actuated.

When the motor is actuated in a first direction, the cam 106 rotates in a first direction disengaging the first follower 130 from the first slot 150, the motor continues to rotate, and the first follower 130 eventually enters into the second slot 152. Eventually, the continued rotation of the cam 106 with the first follower 130 positioned in the second slot 152 begins to translate the blocker 104 along the blocker channel 42. It will be understood that, advantageously, the cam 106 rotates through an arcuate distance prior to engaging the first cam profile with force being directed upon the blocker in a translating direction. In the embodiment shown, the cam 106 rotates through about a half turn prior to initiating the translation of the blocker. Advantageously, the motor is allowed to initiate rotation without load, such that momentum can be built up, which momentum is sufficient to initiate translation of the blocker. Such a momentum building, relatively load free, initiating step removes the need to utilize a gear train to reduce the speed of the cam or to increase the torque applied by the cam. Rather, a direct drive of the cam by the motor (which greatly simplifies the construction) can be utilized.

As the rotation of the cam 106 continues, eventually, the blocker continues to translate due to the interaction of the first follower 130 within the second slot 152 of the first cam profile. Eventually, the first follower 130 reaches a point, as does the blocker 104 wherein the first follower 130 no longer exerts a force on the blocker 104 to translate further. Shortly thereafter, the first follower 130 exits from the second slot 152 and continued rotation directs the first follower 130 into the second slot. When the first follower 130 is fully inserted into the second slot, further movement is precluded. The PC board senses that the first follower is in such a position (i.e., through a sensing of the draw of the motor, or through other means, such as a sensor or the like). The PC board then directs the motor to cease rotation. In another embodiment, a timer can trigger the motor circuit to de-energize the motor. It will also be understood that the cam follower 132 interacts with the second cam profile, and the ramps in order to retain the blocker in proper alignment with slots 152, 154, when the follower is outside of the slots 152, 154, and also prior to entry into these slots.

The blocker is now in the unlocked orientation. That is, the blocker is moved out of the path of the latch channel, and the latch can be slidably moved within the latch channel. The engagement of the cam 106 with the third slot 154 and the interaction of the second follower 132 with the second cam profile, maintains the blocker in the unlocked configuration.

In such a configuration, the user can pull the second member and the lock body apart. As the two are separated, the striker hoop 84 acts upon the jamb slot 70 as it exits from the transverse catch slot 35, all of which motion imparts pivoting of the catch member 60 about the pivot axle 62. Continued pivoting eventually creates an opening between the jamb slot and the transverse catch slot that is sufficient for the striker hoop to pass. At the same time, the catch member pivots directing the latch member to follow along the radial connection portion 77 and the unlocked portion 75, which directs the latch member further into the latch assembly cavity. Without the blocker 104 impeding movement, the latch member is free to slidably move out of the way and to allow the pivoting of the catch member relative to the pivot axle.

Due to the biasing member 114, the distal end 112 of the latch 102 is directed toward and generally into contact with the latch interface surface. In the unlocked condition, the distal end of the latch remains in contact with the latch interface surface 76. At the same time, the blocker 104 is maintained by the cam 106 in the unlocked position to preclude interference with or impeding of the latch. Furthermore, due to the pivoting of the catch member, the spring member has moved to a position wherein the spring member biases the catch member and urges the catch member in a counterclockwise direction, further directing the separation of the striker hoop from the jamb slot.

To relock the lock, the user directs the striker hoop and the housing assembly into contact so that the striker hoop is directed into the transverse catch slot 35. As the striker hoop continues, eventually, the striker hoop enters into the jamb slot and contacts the rearward wall of the jamb slot. Continued movement initiates clockwise pivoting of the catch member about the pivot axle. As the pivoting of the catch member proceeds, eventually, the distal end 112 of the latch 102 encounters the radial connection portion and subsequently, the locked portion (as the spring 114 urges the distal end 112 of the latch 102 to maintain contact with the latch interface surface).

In the embodiment shown, the position sensor 174 in cooperation with position flange 115 senses the position of the latch and, therefore, that the catch member has returned to a locked configuration.

With such a sensing, the motor is instructed to activate by the electronic control 18, in the opposite direction from the direction of rotation during unlocking steps. Namely, the cam 106 is rotated by the motor, and the first follower 130 exits the third slot, extends over the second ridge 153 and enters the second slot 152. Continued rotation imparts a force upon the blocker having a component in the direction of the locked position and the blocker slidably moves toward the locked position along the blocker channel. Eventually, the blocker reaches a translated position wherein the cam 106 no longer slidably moves the blocker. In such a position, further rotation of the cam 106 directs the first follower 130 to exit the second slot, traverse over the first ridge 153 and returns to first slot 150.

Similar to that which was explained above with respect to the unlocking procedure, during the locking procedure, the cam 106 rotates an arcuate distance without the first follower 130 imparting a force on the first cam profile of the blocker. As such, the cam can gather speed, and in turn, momentum, such that when the cam enters the second slot 152, the cam has sufficient force to impart onto the blocker to translate the blocker. Such an intermittent contact with the first cam profile, and intermittent application of a translational force allows for the use of a directly driven cam, and a motor smaller than would otherwise be required. Furthermore, the consumption of power from the battery is reduced for each cycle as compared to a rack and pinion with constant engagement and application of force therebetween.

Once in the first slot 150, the cam 106 is precluded from rotation as the blocker has reached the locked position (i.e., the end of travel of the blocker along the blocking channel). Thus, while rotation is precluded, the motor continues to impart a rotational force on the cam 106, thereby increasing the power draw. The electronic control 18 realizes the increased power draw by the motor as a signal that the blocker has returned to the locked position. In turn, the power to the motor ceases.

In this position, the blocker 104 is in a position that precludes slidable movement of the latch sufficient to move the latch outwardly sufficient to allow the catch member to pivot and have the radial connection portion pass beyond the latch.

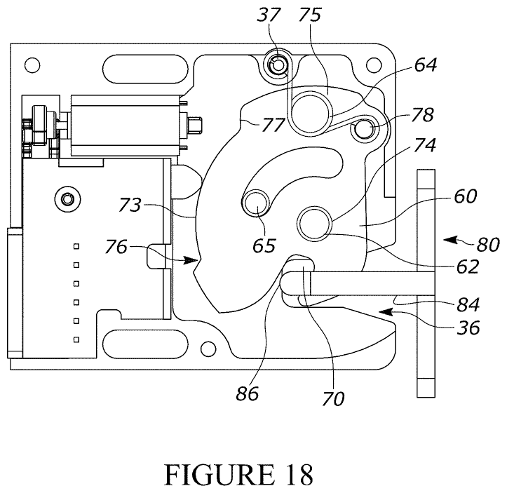

It will further be understood that the locked configuration provides a range of positions. For example, in FIG. 18, the end of travel has been reached for the catch member. In such a configuration, the striker hoop 84 remains within the jamb slot 70 and the transverse catch slot 35 and is therefore precluded from detachment. When compared with FIG. 3, which is also a locked configuration, the catch member 60 is further rotated in the clockwise direction, yet in each configuration the lock remains in the locked orientation (and the distal end 112 of the latch remains in contact with the unlocked portion 75 of the catch member). Such a range of positions facilitates installation by providing a range of locked positions providing some deviation in the relative position of the two components relative to each other.

The foregoing description merely explains and illustrates the invention and the invention is not limited thereto except insofar as the appended claims are so limited, as those skilled in the art who have the disclosure before them will be able to make modifications without departing from the scope of the invention.

1. A lock comprising:
a housing assembly having an actuatable lock cavity and a transverse catch slot providing ingress thereinto;
an actuatable lock assembly positioned within the actuatable lock cavity, and including a catch member rotatably coupled to the housing, the catch member having a jamb slot that slidably accessible through the transverse catch slot when in an open orientation and slidably inaccessible when in a closed orientation;
a latching assembly further comprising:
a latch slidably extending at least partially into the actuatable lock cavity and interfaceable with the catch member wherein the latch assembly can block rotation of the catch member from the closed orientation to the open orientation;
a blocker positioned within the housing assembly and movable between a locked position and an unlocked position, wherein, in the locked position, the blocker precludes movement the latch sufficient to block rotation of the catch member from the closed orientation to the open orientation, the blocker having a cam profile;
a cam rotatably mounted within the housing assembly, the cam having a first follower configured to intermittently coact with the cam profile of the blocker, to, in turn, move the blocker between the locked position and the unlocked position; and
a motor coupled to the cam so as to have the same axis of rotation, whereupon actuation of the motor causes rotation of the cam, and, in turn, movement of the blocker between the locked and unlocked position.

2. The lock of claim 1 wherein the cam profile further comprises an uneven contact profile surface having a concave portion on an outer surface of the uneven contact profile surface.

3. The lock of claim 2 wherein the uneven contact profile surface comprises a combination of at least one of a slot and a ridge.

4. The lock of claim 2 wherein the uneven contact profile surface further comprises a combination of at least one of a peak and a ramp.

5. The lock of claim 1 wherein the first follower is configured to continue rotating after the blocker reaches the locked position, independent of movement of the cam profile, and the follower is configured to continue rotating after the blocker reaches the unlocked position, independent of movement of the cam profile.

6. The lock of claim 1 wherein the motor includes an axle extending therefrom and directly rotatably coupled to the cam so as to have the same axis of rotation.

7. The lock of claim 1 wherein:
the latch has a proximal end and a distal end, with the proximal end interfaceable with the blocker; and
the catch member further includes a latch interface surface that is interfaceable with the distal end of the latch, the latch interface surface having a locked portion, an unlocked portion and a radial portion,
when the catch member is in the closed configuration, and the blocker is in the locked position, the distal end of the latch cooperates with the radial portion to preclude further rotation of the catch member.

8. The lock of claim 7 wherein the catch member further includes a guide slot with a guide pin slidably positionable within the guide slot while being fixed relative to the housing, wherein the guide slot defines the range of rotation of the catch member relative to the housing assembly.

9. The lock of claim 8 wherein further comprising a return spring having a first end coupled to the housing and a second end coupled to the catch member, the return spring directing the catch member so that a first end of the guide slot interfaces with the guide pin when in an open configuration and directing the catch member so that a second end of the guide slot interfaces with the guide pin when in a closed configuration.

10. The lock of claim 7 further comprising a spring biasing the distal end of the latch toward the latch interface.

11. The lock of claim 1 further comprising a second member having a striker hoop, wherein the striker hoop is insertable into the transverse catch slot and into the guide slot when in the open configuration, and wherein further insertion into the transverse catch slot rotates the catch member toward the closed configuration.

12. The lock of claim 1 wherein the striker hoop is capturable by the transverse catch member and the guide slot when the catch member is in the closed configuration.

13. The lock of claim 1 wherein the blocker is slidably movable along a blocker channel of the housing assembly, and wherein the latch is slidably movable along a latch channel of the housing assembly.

14. The lock of claim 13 wherein the blocker channel and the latch channel are substantially perpendicular to each other.

15. The lock of claim 14 wherein the blocker channel is substantially perpendicular to an axis of rotation of the cam.

16. The lock of claim 13 wherein the latch channel includes a latch opening providing ingress into the actuatable lock cavity.

17. The lock of claim 1 wherein upon actuation of the motor, from either the locked or unlocked position, the cam rotates through an initial arcuate distance prior to imparting a force upon the blocker to slidably move the same into the other of the locked or unlocked position.

18. The lock of claim 17 wherein the initial arcuate distance comprises approximately half of a revolution.

19. The lock of claim 1 wherein the blocker further includes a second cam profile disposed thereon, the first and second cam profiles being substantially parallel to each other defining an longitudinal channel therebetween, the cam further includes a body and a second follower, the first follower extending from a first side of the body and the second follower extending from a second side of the body, wherein the cam follower interfaces with the cam profile and the second cam follower interfaces with the second cam profile, with the body of the cam positioned at least partially within the longitudinal channel.

20. The lock of claim 1 wherein the cam profile includes a first slot, a second slot and a third slot, with a first ridge defined between the first slot and the second slot, and a second ridge defined between the second slot and the third slot, the width of the second slot is at least as wide as the follower, such that when the follower engages the second slot, further rotation slidably moves the blocker.

21. A lock for securing a volume to be protected having a closure member, with the closure structure providing ingress into the volume to be protected comprising:
a first member coupled to one of the volume to be protected and the closure member and comprising:
a housing assembly having an actuatable lock cavity and a transverse catch slot providing ingress thereinto;
an actuatable lock assembly positioned within the actuatable lock cavity, and including a catch member rotatably coupled to the housing, the catch member having a jamb slot that slidably accessible through the transverse catch slot when in an open orientation and slidably inaccessible when in a closed orientation;
a latching assembly further comprising:
a latch slidably extending at least partially into the actuatable lock cavity and interfaceable with the catch member wherein the latch assembly can block rotation of the catch member from the closed orientation to the open orientation;
a blocker positioned within the housing assembly and movable between a locked position and an unlocked position, wherein, in the locked position, the blocker precludes movement the latch sufficient to block rotation of the catch member from the closed orientation to the open orientation, the blocker having a cam profile;
a cam rotatably mounted within the housing assembly, the cam having a first follower configured to intermittently coact with the cam profile of the blocker, to, in turn, move the blocker between the locked position and the unlocked position; and
a motor coupled to the cam so as to have the same axis of rotation, whereupon actuation of the motor causes rotation of the cam, and, in turn, movement of the blocker between the locked and unlocked position; and
a second member coupled to the other of the volume to be protected and the closure member, and comprising:
a striker hoop, wherein the striker hoop is insertable into the transverse catch slot and into the guide slot when in the open configuration, and wherein further insertion into the transverse catch slot rotates the catch member toward the closed configuration, thereby corresponding in a closed configuration of the closure member relative to the volume to be protected.

22. The lock of claim 21 wherein the second member further includes a base plate, with the striker hoop extending from the base plate and with the base plate being attached to the one of the volume to be protected and the closure member.

23. The lock of claim 21 wherein the volume to be protected comprises one of a doors, drawers, cabinets, pantries, desks, credenzas, and wardrobes.

24. The lock of claim 21 wherein the closure member comprises a door or a drawer.

25. The lock of claim 1 wherein the housing assembly further comprises a bottom, a first side, a second side, a first end and a second end, wherein the bottom is attached to the one of the volume to be protected and the closure member, and further comprising a cover that is releasably attachable to the at least one of the base, the first side, the second side, the first end or the second end.

26. The lock of claim 1 wherein the motor is controlled by an electronic control system a portion of which is positioned within the housing assembly.

27. The lock of claim 1 wherein the electronic control assembly includes an input device, which comprises at least one of a key, a keypad having a plurality of keys, a receiver structurally configured for receipt of wireless signals from key cards, mobile phones, or other devices.
